(19) United States
(12) Patent Application Publication
(10) Pub. No.: US 2015/0106685 A1
(43) Pub. Date: Apr. 16, 2015

(54) TRANSFORMING A DOCUMENT INTO WEB APPLICATION

(71) Applicant: Thrivon Management Consulting, McLean, VA (US)

(72) Inventor: Rakesh Gupta, Fairfax, VA (US)

(73) Assignee: Thrivon Management Consulting, McLean, VA (US)

(21) Appl. No.: 14/051,305

(22) Filed: Oct. 10, 2013

(51) Int. Cl. G06F 17/22; G06F 17/24; G06F 17/30

(52) U.S. Cl. CPC G06F 17/227; G06F 17/30011; G06F 17/248
USPC 715/234

(57) ABSTRACT

Transforming an electronic document into web application provides a single interactive platform for conducting all business activities, including collaboration. This significantly extends the simple, persistent, portable and contextual nature of a document with interactive, authoritative, process oriented and data connected capabilities of a web application. The application aspect of the document also ensures the metadata of document is always up-to-date and self-managed, with the corresponding data and content provided in the document, for accurate search and retrieval. The invention transforms isolated, static and manual characteristics of document into a rich and live application. Instead of it being the end result of a process, the document itself serves as the platform that allows business processes to be launched, conducted and completed within the document itself, thereby saving users the hassle of opening multiple forms, screens, emails in order to finalize the content. This allows the data and content to be negotiated within the document itself. In other words, the document becomes an interactive, connected, living and breathing entity which can respond to the changing business needs, immediately and automatically.

### CROSS REFERENCES TO RELATED APPLICATIONS

This application claims benefit of Provisional Application No. 61/713,259 filed on Oct. 12, 2012.

### BACKGROUND OF THE INVENTION

Documents frequently need to include data and content that might be created and managed in different corporate information systems. Document authors incorporate this required data by manually seeking and compiling it through exposed corporate applications. This manual process is highly inefficient and error prone.

Majority of the business transactions usually involves two or more parties to agree upon the content of “document” (such as a loan agreement, sales order, purchase order, lease agreement etc.). Once parties agree upon the document content (which may include terms, conditions, prices, quantity etc.), the transaction is completed by parties signing on the document. Current processes of emailing documents around and reconciling or even check in checkout from a collaboration workspace is highly inefficient because much of the collaboration happens around the document and not within or on the document. Also, during collaboration, the author has nearly no control on how the document content (such as terms, conditions, prices, quantity etc.) gets defined, authorized and edited (In other words, the author has no control in defining which reviewer can edit what portions of the document).

Also, once the content is reviewed and ready, branding the document with professional look that includes headers, footers, watermark, sidebars etc., is currently a time consuming manual process, which thus is inefficient and subject to non-compliance.

Finally, tracking and reporting on documents, is currently managed by manually maintaining the document metadata. This again is very inefficient and error prone, because, each time a document content such as “document expiration date” changes, it's relevant metadata has to be updated and maintained manually in the corresponding document's system or record.

In short, the challenge is to gain better control of the document composition process to improve responsiveness, completeness, correctness, collaboration, personalization, branding, efficiency, integration with other available data sources, tracking and reporting.

### SUMMARY OF THE INVENTION

The object of this invention is to provide solution to above discussed background of document composition challenges and limitations. This invention features transforming a document into web application. Conventional enterprise software offer web browser based applications that end their functionality at the creation of these “documents” within a computerized system. All of the subsequent exchange of information happens by emailing or physically mailing the documents back and forth until the parties come to a common understanding of and agree upon the content of the document. To put it simply, “today documents are the end result of application”. This invention transforms a document into a live application, that can allow business processes to be launched, conducted and completed within the document itself, thereby saving users the hassle of opening multiple applications, screens, emails in order to finalize the content.

The embodiment of this invention is provided in FIG. 1 and FIG. 2. More specifically, the invention enables a document to a server as an interactive computer system platform for all business activities, be it local or networked. The document becomes the centerpiece, which interacts and integrates with databases and other computer systems. The document as the application also extends security on the document content by enabling access control to virtually any paragraph within the document. It also serves as the collaboration platform by allowing users and reviewers to interact with each other within the document itself, while tracking all edits and maintaining complete history either in local mode or networked. Finally the presentation layer is kept decoupled from the document content and different branding templates can be applied on demand, based on the document type and format.

The invention provides means for defining document templates with configurations for external data connectivity and elastic metadata mappings via computer processors. These customized, configured and defined templates serve as the starting point for document creation and allow documents to bind data at run time. This feature allows a document to behave as a form allowing data to be fetched from, or pushed to its configured data source(s) hence eliminating the need for authors to key in or copy paste information manually. This feature also helps maintain a single version of data at its managed data source(s). Furthermore the elastic metadata mappings allow for document's metadata to be automatically populated and be self-managed with edits in the document. This greatly improves search and retrieval of the document. In a contract document, for example, if “document expiration date” has been configured and mapped to its corresponding metadata, whenever this information is changed in the document, the metadata can be automatically updated which significantly improves the accuracy of search and retrieval operations like find contracts where “document expiration date” is greater than 01/01/2012.

The invention also provides means of keeping single active document while tracking all changes to the document on demand, during collaboration via computer processors. With each save of the document, a sophisticated comparison against the electronic master copy is performed and the output is displayed in a single document, which becomes the new active document. This active document tracks what content has been changed, by whom and when. This feature of the innovation allows for the document to be edited in any number of client types, such as web browser, MS Word on pc, iPad or other stationary or mobile devices. The active document reflects the changes in a consistent manner, irrespective of the client in which the document is being viewed or edited. Furthermore the tracked changes can be displayed online within the document or be represented in a separate report. The document author also has a control on how the document gets reviewed in collaboration system. The author can establish one or more sections in the document, set invite for various reviewers and configure what sections or paragraphs are hidden, viewable or editable by which reviewers. The comparison and tracking feature of the inventions allows and promotes simultaneous review and editing of the document during collaboration, in relation to each of the reviewers and their rights. The experience is similar to a web application page being accessed simultaneously by multiple users.

The invention also features a single click automated finalizing of document. Once the document content is ready, the document author can finalize the document by clicking a single button, which applies the branding template on the active document and displays the output in PDF or MS Word format or any other editing tools specified. The branding template itself is customizable and allows for defining of headers, footers, sidebars, watermarks and more. This feature ensures that standard branding information, compliant with corporate standards, is consistently applied to all documents.

With this invention, the document gets transformed into a web application and composing a document becomes a highly efficient, automated, collaborative and interactive experience, thus improving speed, transparency and compliance with rules and configurations set up by the users and/or collaborators.

### BRIEF DESCRIPTION OF THE DRAWINGS

FIG. 1 is a schematic block diagram illustrating the system architecture of document being transformed into an application.

FIG. 2 is a schematic block diagram illustrating the business functionality of document being transformed as an application.

FIG. 3 is a listing of few key features of document being transformed as an application.

FIG. 4 is a diagram depicting use case scenarios associated with template defining and publishing process.

FIG. 5 is a diagram depicting use case scenarios associated with draft authoring process.

FIG. 6 is a diagram depicting use case scenarios associated with draft review and collaboration process.

### DETAILED DESCRIPTION OF THE INVENTION

In the following detailed description, references are made to the accompanying drawings which form a part hereof, and in which are shown by way of illustrations embodiment in which the invention may be practiced. It is to be understood that other embodiments may be utilized and structural or logical changes may be made without departing from the scope of the present invention. Therefore, the following detailed description is not to be taken in a limiting sense.

Various operations may be described as multiple discrete operations in turn, in a manner that may be helpful in understanding embodiments of the present invention; however, the order of description should not be construed to imply that these operations are order dependent.

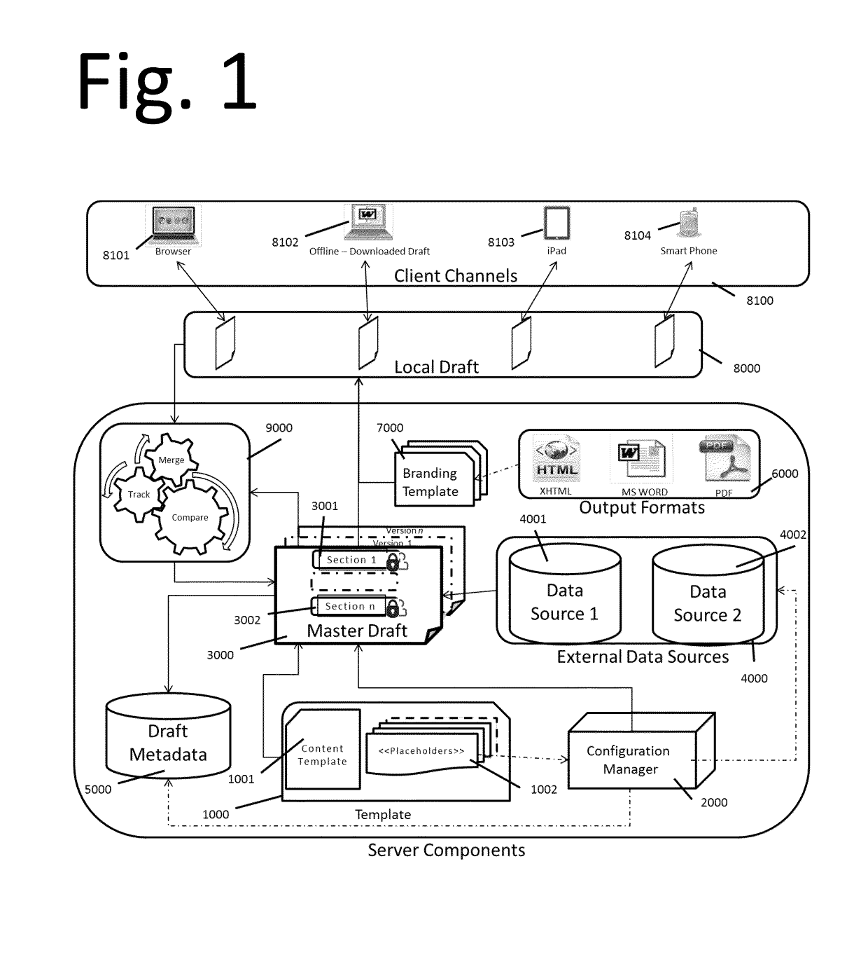

Embodiments of the present disclosure describe how a document can be transformed into a web application. FIG. 1 Illustrates example architecture of how a document can be transformed into a web application. The transformation begins with defining a document Template 1000. The template definition comprises of two important elements, a content template 1001 and placeholder 1002. Content template 1001 lays out the boiler text as it should appear in draft document. Placeholders 1002 are given meaningful names and weaved within the content template 1001. Placeholders 1002 serve as position identifiers where special actions would take place during the electronic master draft 3000 composition. The special actions could include fetching data from external data sources 4000 into the placeholders 1002 or vice versa, or it could include updating draft metadata 5000 from placeholders' 1002 content, or both. The mapping of these special actions is defined in configuration manager 2000.

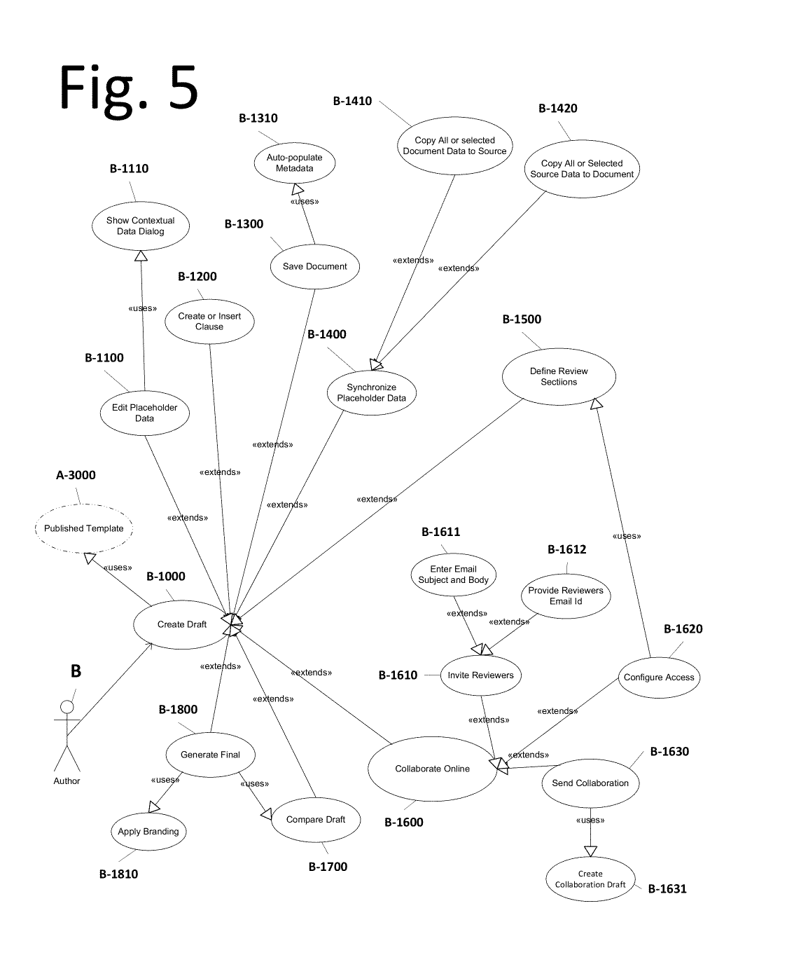

Electronic master draft 3000 is the most important element in this architecture shown in FIG. 1. It is in this element that much of the application concepts are applied. To begin with, template 1000, along with its content 1001 and placeholders 1002 is first used to create this electronic master draft 3000 via computer system. Next, based on configurations defined in configuration manager 2000 and author's actions or the context of “project” where the electronic master draft 3000 is created, the placeholders 1002 within the electronic master draft 3000 get populated with data corresponding to their mapped data sources 4000. In this embodiment, the placeholders 1002 are provided as hyperlinks which when clicked, use case B-1100 (in FIG. 5) presents the author with a contextual data dialog B-1110 (in FIG. 5) to fetch or push data to its mapped data source(s) 4000 as defined in the configuration manager 2000. The layout of the contextual data dialog, use case B-1110 (in FIG. 5), is also defined in the configuration manager 2000. This invention with the ability of placeholders 1002 to be able to read/write data from/to its data source(s) 4000 allows for the document 3000 itself to behave as a web form.

The user can further edit the text, placeholder data or both, in the electronic master draft 3000 as deemed necessary. The user can interact with the electronic master draft 3000 through any of the client interaction channels 8100 such as web browser 8101, iPad 8103, other Smart Phones 8104 or any stationary or mobile devices. The user can even download a copy of electronic master draft as an editable file, 8102, which can be edited offline. In all these interactions, a local draft copy 8000 is first created. Edit made by user are first maintained in the local copy and with each save, which can be manual or automatic, the local edits are run though compare, track merge engine 9000, which as the name suggests, first compares the current local draft 8000, with original active electronic master draft 3000, then notes the differences and tracks them with name of the local draft user and the time the save was made, and finally merges the compared and tracked changes into the electronic master draft 3000, thus creating a new active electronic master draft 3000. This compare, track, merge process 9000 is repeated for each reviewer during collaboration, explained later. Also, this process 9000 can be called, on demand, to compare any two documents or versions within the system, use case B-1700 (in FIG. 5).

Once the author has made the necessary edits to the electronic master draft 3000, the author can then invoke collaboration to negotiate on the document. This embodiment shown in FIG. 1, allows for collaboration within the document. To begin with, author can select various text, one or many paragraphs, within the electronic master draft 3000 and mark them as virtual sections 3001, 3002, use case B-1500 (in FIG. 5). These sections 3001, 3002 serve as the new granular level objects for extended security and authorization. Next, author can provide email information, use case B-1610 (in FIG. 5), including addresses of reviewers, use case B-1612 (in FIG. 5), that the author might want to collaborate with. Once the list of reviewers has been established, the author can then configure access, use case B-1620 (in FIG. 5) by setting access level on each of the earlier defined sections for each of the reviewers listed for collaboration in a matrix format. In the current embodiment the author can set three levels or access for each section and each reviewer. The three access levels are: None, Read and Edit. Access level “None” on a particular section 3001 implies, the reviewer would not see the section. It would be as if the document never had the section 3001 listed in the document. Access level “Read” on a particular section, say 3002 for a particular reviewer, implies, the reviewer can view that section but would not be able to edit that section 3002. Likewise, access level “Edit” on a particular section, say 3002, implies the reviewer can read and edit that section 3002. This section level access based security transforms a document 3000 into high level application object with decomposed and author defined lower level sections' 3001, 3002 asset based authorization.

Furthermore, the electronic master draft document 3000 can be viewed in multiple output formats 6000. Current embodiment of this invention as illustrated in FIG. 1 supports three formats: XHTML, MS Word and PDF. XHTML is the default format in which the Electronic master Draft 3000 is always maintained but on demand or based on client channels 8100, the electronic master draft 3000 can be exported to the other two formats 6000. Current embodiment also supports multiple branding 7000, use case B-1810 (in FIG. 5) based on the output format 6000 and/or the document type such as draft copy, collaboration copy or finalized copy. This concept is similar to web application development where presentation layer is kept separate from the business logic and different “skins” can be applied based on the context of audience.

Current embodiment of this invention also allows for automatic metadata updates, use case B-1310 (in FIG. 5). The configuration manager 2000 defines the mappings of placeholders 1002 to draft metadata 5000. Once mapped, each time the electronic master draft 3000 get saved, content of its mapping defined placeholders 1002 is extracted and applied against the corresponding draft metadata 5000. This greatly enhances the search and retrieval capabilities of the document with the metadata getting accurately reported. As an example, in a contract document 3000, if “document expiration date” placeholder 1002 has been configured and mapped to its corresponding metadata 5000 then whenever this information is changed in the document, the metadata can be automatically updated. This significantly improves the accuracy of search and retrieval operations like find contracts where “document expiration date” is greater than 01/01/2012.

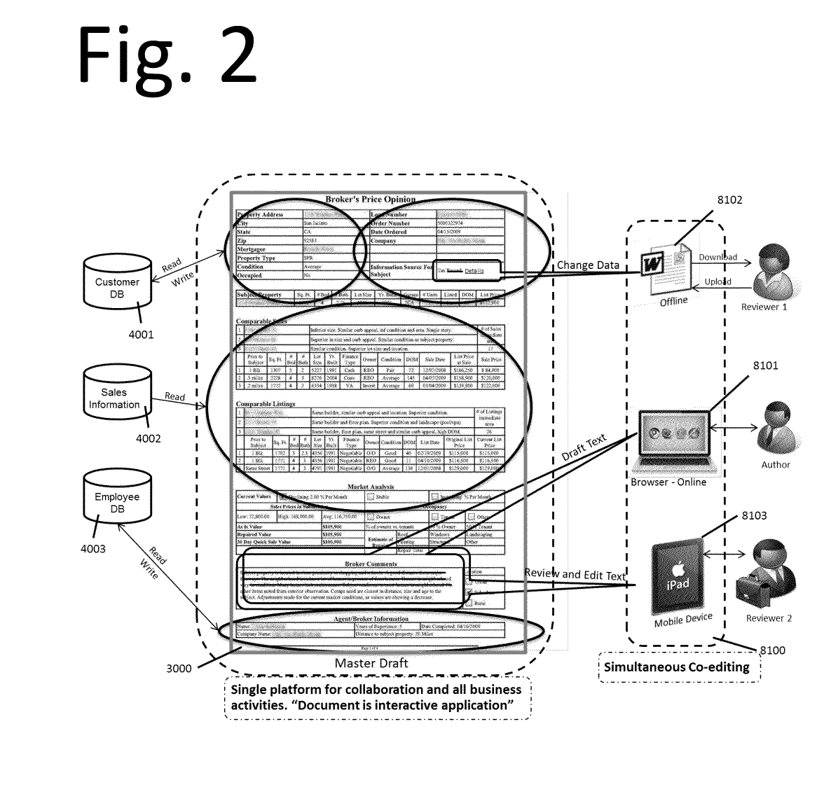

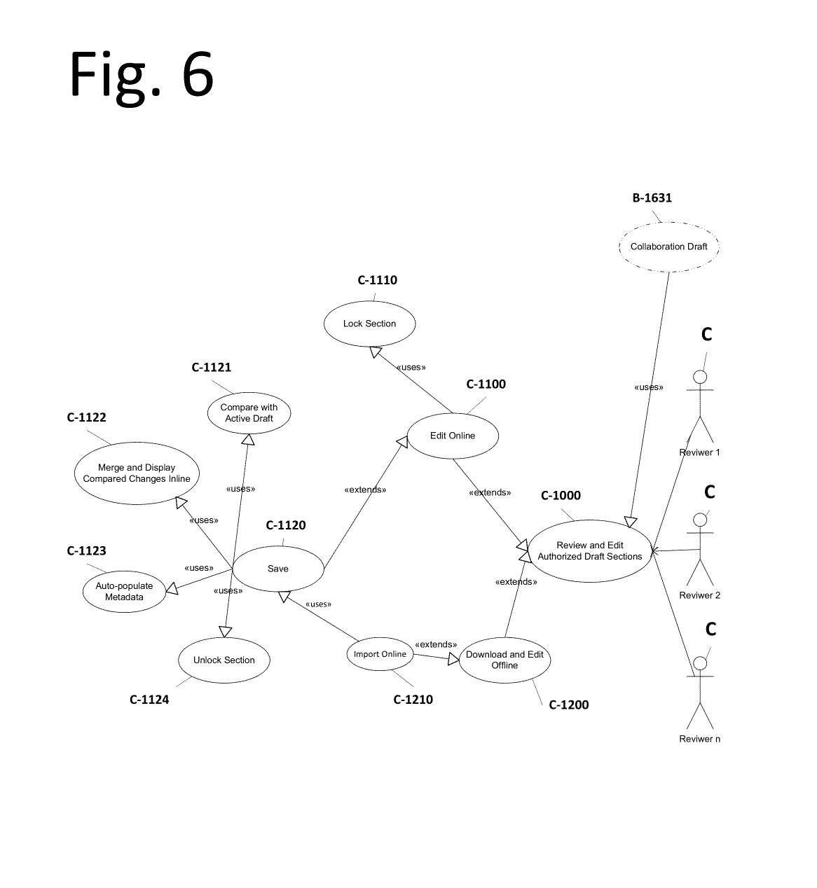

FIG. 2 illustrates the anatomy of a document and how various users might interact with it in the embodiment of the invention and use cases in FIG. 6. Illustrate a sample review process. First, author prepares the electronic master draft 3000 by importing data in its placeholders from its data sources, 4001, 4002, 4003, drafts initial text in browser, 8101 in FIG. 2 and submits it for collaboration, use case B-1600 in FIG. 5, with two reviewers. Reviewer 1 downloads the document in MS Word and edits it offline 8102 in FIG. 2, use case C-1200 in FIG. 6. At the same time, Reviewer 2 simultaneously edits the document online 8103 in FIG. 2, use case C-1100 in FIG. 6. Reviewer 1 and Reviewer 2 have edit access to all sections but they work on two different sections. Editing a section online, such as 8100 edited by Reviewer 2, in FIG. 2, also locks that section, use case C-1110 in FIG. 6, such that no other reviewers can edit that section.

With each of the reviewer edits and save, the following use cases are invoked. First, compare with active electronic master draft, use case C-1121 in FIG. 6, is invoked to compare reviewer's local working draft with electronic master draft. All changes are duly noted, then tracked with reviewer's name, time of save and position of the change. A unique color is assigned to each of the reviewers. These changes in reviewer unique color and with tracking information are then merged and displayed inline, use case C-1122 in FIG. 6, in red lined format (underline for inserted text and strike though for deleted text). Along with saving the text of the document, the metadata is automatically harvested from the document, if any of the data in placeholders have changed and applied to its mapped metadata, use case C-1123 in FIG. 6. Finally the section being saved in unlocked, use case C-1124 in FIG. 6, and becomes available for editing by any of the other reviewers.

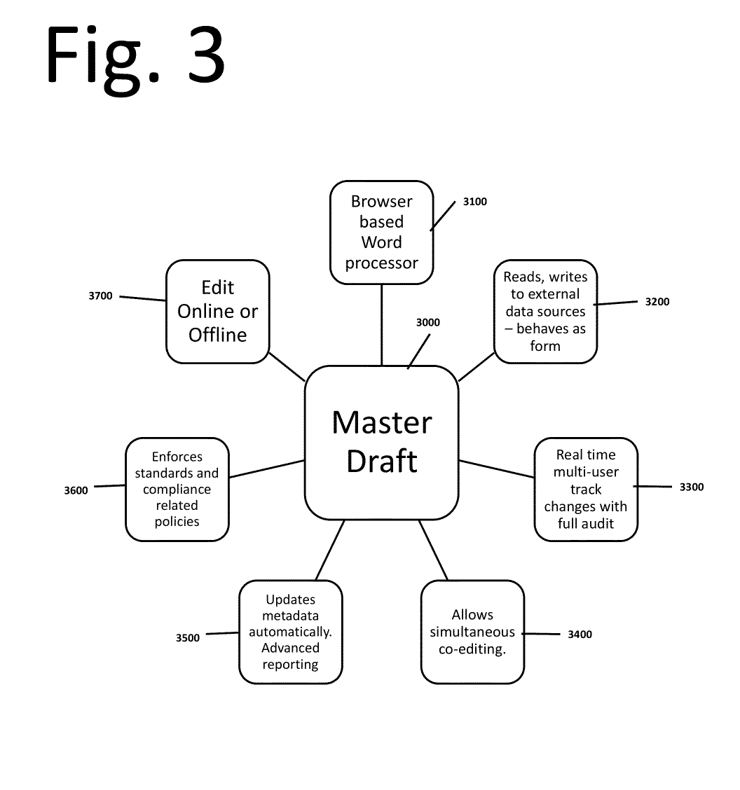

Electronic master draft serves as a single platform for collaboration and all business activities. Its design and application in the invention is what transforms the document into an interactive web application. Some of the other features, as illustrated in FIG. 3 are as follows:
Electronic master draft can be edited in web browser 8101 in FIG. 1. As such it behaves like a browser based word processor, 3100 in FIG. 3.
Electronic master draft can read/write from/to external data sources. In this aspect is behaves as a web form, 3200 in FIG. 3, use case B-1100 in FIG. 5.
Electronic master draft show user edits in real time multi-user track changes or red line format, 330 in FIG. 3, as described above, use case use case C-1122 in FIG. 6.
It allows simultaneous co-editing, 3400 in FIG. 3.
Draft metadata is updated automatically, 3500 in FIG. 3, use case B-1310 in FIG. 5 and use case C-1123 in FIG. 6. This metadata is needed for advance reporting and auditing. It also help with accurate search and retrieval of documents
Electronic master draft enforces standards and compliance related policies, 3600 in FIG. 3. Since the starting point of electronic master draft is always a template, 1000 in FIG. 1, use case B-1000 in FIG. 5, the document always starts with a compliant and standards based document. Furthermore, the placeholders fetch data from their authoritative data source as such the data within the document gets automatically corrected and compliant. Finally since the presentation of the document is defined by branding templates, 7000 in FIG. 1, the final generated document applies the standards based content, data and branding.
The draft can be edited by online, use case C-1100 in FIG. 6, in browsers 8101 in FIG. 1, ipad 8103 in FIG. 1 or other mobile devices 8104 in FIG. 1 or offline, use case C-1200 in FIG. 6 where it can be downloaded in MS Word, 8102 in FIG. 1 and FIG. 2
Electronic master draft can also be decomposed into various virtual sections, 3001 and 3002 in FIG. 1, use case B-1500 in FIG. 5, by the author. Each of these sections can then act as granular object which can be configured for access, use case B-1620 in FIG. 5 with various authorization levels, (none, read or edit), for each of the reviewers.

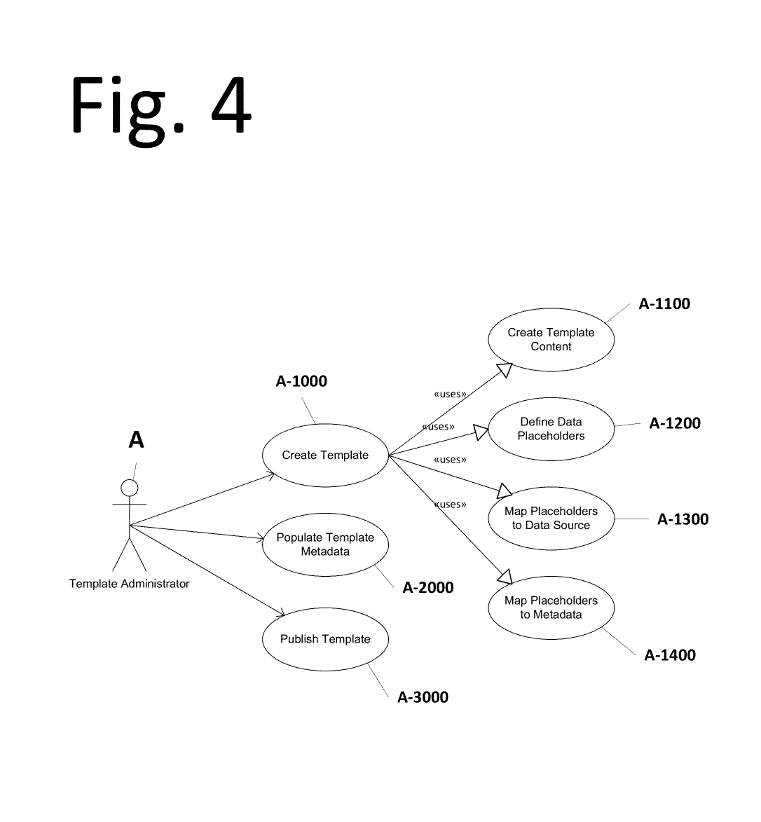

Most of the electronic master draft capabilities and features begin with layout, content, 1001 in FIG. 1, and placeholders, 1002 in FIG. 1, defined in its parent template 1000 in FIG. 1. FIG. 4 illustrates various use cases, which help electronic master draft inherit much of its application capabilities. Use Case A-1000, create template comprises of four key child use cases. The first being, create template content, use case A-1100. During this use case, the text and layout of the content is put is MS Word. Next, in use case A-1200, define data placeholder, positions where external data needs to retrieve in the document are located, placeholders are given meaningful names and then each of these placeholder are appropriately mapped. As an example, once such placeholder could be address or the contractor. This could be mapped to, say, contractor address in contactor's DB, during use case A-1300 in FIG. 4, (map placeholders to data source. This mapping would result in electronic master draft getting the address of named contractor with author's click of edit placeholder data, use case B-1100 in FIG. 5. The same place holder could also be mapped to metadata, use case A-1400. The placeholder mapping to draft metadata enriches the system with accurate search and retrieval capabilities. As an example, this electronic master draft with contractor's address can easily be found by searching against the address metadata with support for advanced operations such as “find all document where contractor address begins with ‘1600 Tysons Boulevard’”. In the event that the document content is updated with latest contractor address, the document metadata is automatically updated in the system and these results in keeping the document metadata in synch with document content this returning accurate search results.

Note that the template actually becomes available to authors only after it has been published by template administrator, use case A-3000. Also, the predecessor to publishing a template is use case A-2000, populate template metadata.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments, which as a matter of language might be said to fall there between.

I claim:

1. A method for transforming a document to a web collaborative application, comprising:
at least one processor coupled to a memory;
creating a template by defining content, and at least one data placeholder;
a first mapping by said at least one processor, which comprises: mapping said at least one data place holder to at least one data source; and
a second mapping by said at least one processor, which comprises: mapping said at least one data placeholders to a searchable metadata.

2. The method as claimed in claim 1, wherein said first mapping allows pushing and/or pulling said at least one data place holder to and/or from said at least one data source.

3. The method as claimed in claim 2 wherein the said method further comprises:
synchronizing said at least one data placeholders with at least one data source respectively with a single button click.

4. The method as claimed in claim 1, wherein said second mapping allows updating said searchable metadata in real time automatically.

5. The method as claimed in claim 1, wherein said method further comprises: virtually partitioning said document as a master draft copy to at least one partition; assigning at least one collaborator to said at least one partition, wherein said at least one collaborator is authorized to perform a function which includes read, edit, admin, or no access.

6. The method as claimed in claim 4, wherein said function is accessible by web browser, mobile device, and/or desktop client as a local draft copy.

7. The method as claimed in claim 4, wherein said edit function comprises, comparative editing by tracking collaborator's edits in red line.

8. The method as claimed in claim 7, wherein said comparative editing comprises comparing the local draft copy with the master draft copy and presenting the changes at a place of occurrence in red line with a unique color assigned to each collaborator.

9. The method as claimed in claim 7, wherein said changes are displayed inline at said place of occurrence with said document.

10. The method as claimed in claim 7, wherein said changes are displayed as a summary of red line changes clubbed together.

11. The method as claimed in claim 1, wherein said method further comprises: applying branding to said document to generate a final copy.

12. The method as claimed in claim 1 wherein said applying branding to set document comprises:
a. defining and creating a branding template based on at least one custom headers, and/or at least one custom footer and/or at least one sidebar and/or at least one watermark;
b. applying the branding template to said document

13. A system for transforming a document to a web collaborative application, comprising:
at least one processor coupled to a memory, wherein said processor creates a template by defining content, and at least one data place holder;
maps said at least one data place holder to at least one data source, and to a searchable metadata.

14. The system as claimed in claim 13, wherein said at least one processor pushes and/or pulls said at least one data place holders to and/or from said at least one data source.

15. The system as claimed in claim 14, wherein said at least one processor synchronizes said at least one data place holder with at least one data source respectively with a single button click.

16. The system as claimed in claim 13, wherein said at least one processor updates said searchable metadata in real time automatically.

17. The system as claimed in claim 13, wherein said at least one processor virtually partitions said document as a master draft copy to at least one partition; and
allows assigning at least one collaborator to said at least one partition, wherein said at least one collaborator is authorized to perform a function which includes read, edit, admin, or no access.

18. The system as claimed in claim 17, wherein said at least one processor allows said function to be accessible by web browser, mobile device, and/or desktop client as a local draft copy.

19. The system as claimed in claim 17, wherein said at least one processor performs comparative editing by tracking collaborator's edits in red line.

20. The system as claimed in claim 19, wherein said at least one processor performs said comparative editing which further comprises, by comparing the local draft copy with the master draft copy and presenting the changes at a place of occurrence in red line with a unique color assigned to each collaborator, wherein said changes are displayed inline at said place of occurrence with said document, and further displayed as a summary of red line change combined together.
